(19) United States
(12) Patent Application Publication
(10) Pub. No.: US 2009/0310050 A1
(43) Pub. Date: Dec. 17, 2009

(54) DISPLAY SUBSTRATE AND DISPLAY APPARATUS HAVING THE SAME

(75) Inventors: Kyoung-Ju SHIN, Hwaseong-si (KR); Chong-Chul Chai, Seoul (KR); Se-Young Song, Uijeongbu-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/419,750

(22) Filed: Apr. 7, 2009

(30) Foreign Application Priority Data
Jun. 17, 2008 (KR) 2008-56665

(51) Int. Cl. G02F 1/1337; G02F 1/1339; G02F 1/1343

(52) U.S. Cl. 349/39; 349/155; 349/123

(57) ABSTRACT

The present invention relates to a display substrate and display apparatus, an exemplary embodiment of which includes a first switching element, a first spacer arranged on the first switching element, a first pixel electrode connected to the first switching element, a first capacitor electrode connected to the first pixel electrode and arranged on the first spacer, a first storage line overlapping with the first pixel electrode and a first alignment layer arranged on the first pixel electrode and the first capacitor electrode.

### CROSS REFERENCE TO RELATED APPLICATION

This application claims priority from and the benefit of Korean Patent Application No. 2008-56665, filed on Jun. 17, 2008, which is hereby incorporated by reference for all purposes as if fully set forth herein.

### BACKGROUND OF THE INVENTION

1. Field of the Invention

The present invention relates to a display substrate and a display apparatus having the display substrate. More particularly, embodiments of the present invention relate to a display substrate for a liquid crystal display (LCD) apparatus and a display apparatus having the display substrate.

2. Discussion of the Background

Generally, a liquid crystal display (LCD) panel includes a display substrate having a thin-film transistor (TFT) as a switching element to drive a pixel, an opposite substrate facing the display substrate, and a liquid crystal layer interposed between the display substrate and the opposite substrate. An image is displayed on the LCD panel according to the light transmittance of liquid crystal material, which changes according to voltages applied to the LCD panel.

The display substrate includes the TFT, signal lines connected to the TFT, a storage line, an organic layer and a pixel electrode. The organic layer is formed on an insulation substrate having the signal lines, the TFT and the storage line. The pixel electrode is formed on the organic layer. A storage capacitor (Cst) of the pixel is defined by the storage line, the pixel electrode and the organic layer interposed between the storage line and the pixel electrode. The storage line and the pixel electrode serve as electrodes spaced apart from each other, and the organic layer serves as a dielectric substance.

The electric capacity of the storage capacitor is proportional to an overlapping area of the storage line and the pixel electrode and is inversely proportional to the thickness of the organic layer. Thus, in order to increase the electric capacity of the pixel, an overlapping area may be widened and/or the thickness may be decreased. However, widening the overlapping area is typically accompanied by an increase in the width of the storage line, and thus the aperture ratio of the display substrate may be decreased and display quality may deteriorate.

### SUMMARY OF THE INVENTION

The present invention provides a display substrate and display apparatus capable of having an improved electric capacity and aperture ratio.

Additional features of the invention will be set forth in the description which follows, and in part will be apparent from the description, or may be learned by practice of the invention.

The present invention discloses a display substrate including a first switching element, a first spacer, a first pixel electrode, a first capacitor electrode and an alignment layer. The first switching element is connected to a plurality of signal lines. The first spacer is arranged on the first switching element. The first pixel electrode contacts with a drain electrode of the first switching element. The first pixel electrode is connected to the first capacitor electrode. The first capacitor electrode is arranged on the first spacer. The alignment layer is arranged on the first pixel electrode and the first capacitor electrode. The display substrate may further include a first storage line overlapped with the first pixel electrode.

The present invention also discloses a display apparatus including a display substrate and an opposite substrate facing the display substrate. The display substrate comprises a first switching element connected to a first pixel electrode, a first spacer arranged on the first switching element, a first capacitor electrode connected to the first pixel electrode and arranged on the first spacer, and a first alignment layer arranged on the first pixel electrode and the first capacitor electrode. The display substrate may further include a first storage line overlapped with the first pixel electrode. The opposite substrate is combined with the display substrate to interpose liquid crystal molecules. The opposite substrate comprises a common electrode facing the first pixel electrode and the first capacitor electrode, and a second alignment layer formed on the common electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view illustrating a display apparatus in accordance with a first examplary embodiment of the present invention.

FIG. 2A and FIG. 2B are cross-sectional views along lines IA-IA′ and IB-IB′, respectively, of FIG. 1.

FIG. 3A, FIG. 4A, FIG. 5A, and FIG. 6A are cross-sectional views illustrating a method of manufacturing the pixel region shown in FIG. 2A. FIG. 3B, FIG. 4B, FIG. 5B, and FIG. 6B are cross-sectional views illustrating a method of manufacturing the pixel region shown in FIG. 2B.

FIG. 7 is a plan view illustrating a display apparatus in accordance with a second exemplary embodiment of the present invention;

FIG. 8A and FIG. 8B are cross-sectional views along lines IIA-IIA′ and IIB-IIB′, respectively, of FIG. 7.

FIG. 9A and FIG. 10A are cross-sectional views illustrating a method of manufacturing the pixel region shown in FIG. 8A. FIG. 9B and FIG. 10B are cross-sectional views illustrating a method of manufacturing the pixel region shown in FIG. 8B.

FIG. 11 is a plan view illustrating a display apparatus in accordance with a third exemplary embodiment of the present invention.

FIG. 12A, FIG. 12B and FIG. 12C are cross-sectional views along lines IIIA-IIIA′, IIIB-IIIB′ and IIIC-IIIC′, respectively, of FIG. 1.

FIG. 13 is a plan view illustrating a display apparatus in accordance with a fourth exemplary embodiment of the present invention.

FIG. 14A and FIG. 14B are cross-sectional views along lines IVA-IVA′ and IVB-IVB′, respectively, of FIG. 13.

### DETAILED DESCRIPTION OF THE ILLUSTRATED EMBODIMENTS

The present invention is described more fully hereinafter with reference to the accompanying drawings, in which embodiments of the present invention are shown. The present invention may, however, be embodied in many different forms and should not be construed as limited to the embodiments set forth herein. Rather, these embodiments are provided so that this disclosure is thorough, and will fully convey the scope of the present invention to those skilled in the art. In the drawings, the size and relative sizes of layers and regions may be exaggerated for clarity. Like reference numerals in the drawings denote like elements.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

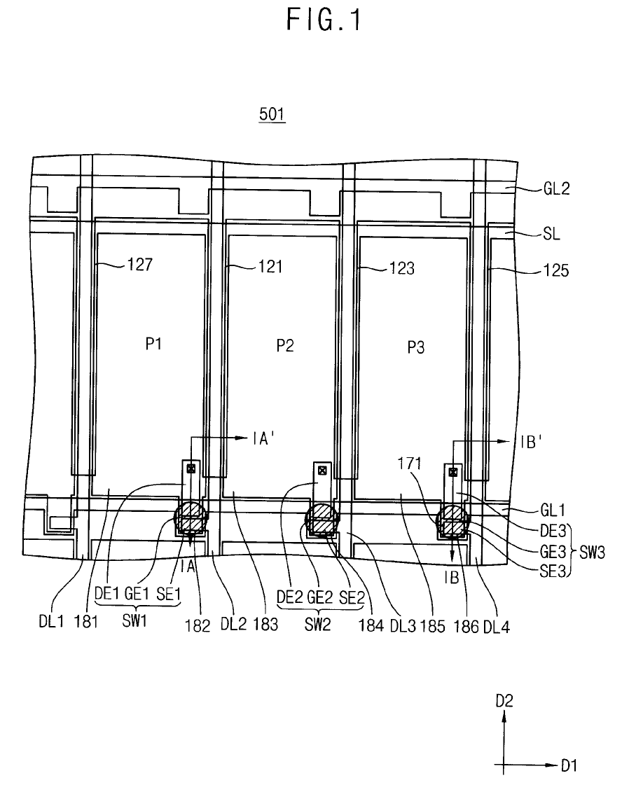

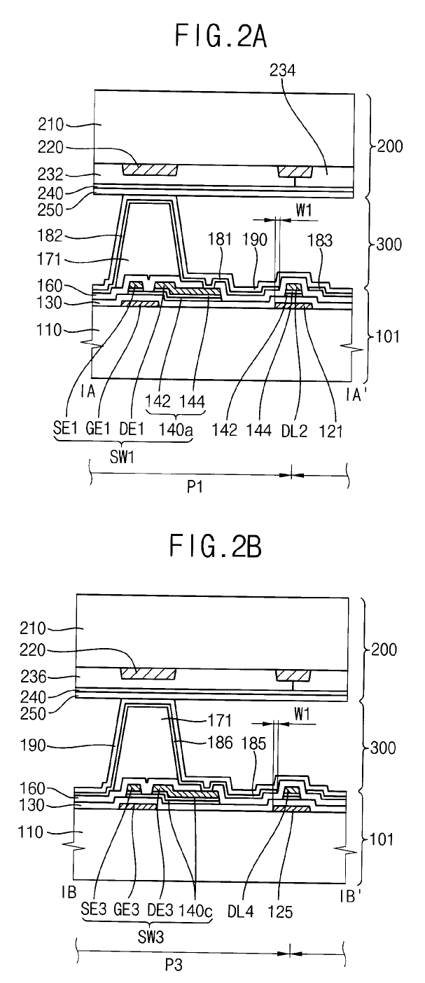

Hereinafter, a display substrate and display apparatus according to a first exemplary embodiment of the present invention will be described with reference to FIG. 1 and FIG. 2.

FIG. 1 is a plan view illustrating a display apparatus in accordance with a first exemplary embodiment of the present invention. FIG. 2A and FIG. 2B are cross-sectional along lines IA-IA′ and IB-IB′, respectively, of FIG. 1.

FIG. 2A is a cross-sectional view illustrating a first pixel region of the display apparatus, and FIG. 2B is a cross-sectional view illustrating a third pixel region of the display apparatus.

Referring to FIG. 1, FIG. 2A, and FIG. 2B, a display apparatus 501 in accordance with a first embodiment of the present invention includes a first display substrate 101, an opposite substrate 200 and a liquid crystal layer 300.

The first substrate 101 includes a plurality of signal lines GL1, GL2, DL1, DL2, DL3 and DL4 formed on a first base substrate 110, a plurality of storage lines 121, 123, 125 and 127, a plurality of thin-film transistors (TFTs) SW1, SW2 and SW3 serving as switching elements, a plurality of pixel electrodes 181, 183 and 185 connected to the TFTs SW1, SW2 and SW3, a plurality of capacitor electrodes 182, 184 and 186, a plurality of first spacers 171 and a first alignment layer 190.

The signal lines include a plurality of gate lines GL1 and GL2 and a plurality of data lines DL1, DL2, DL3 and DL4. The gate lines GL1 and GL2 and the data lines DL1, DL2, DL3 and DL4 cross each other and then divide a plurality of pixel regions P1, P2 and P3.

The gate lines GL1 and GL2 include a first gate line GL1 and a second gate line GL2. The first gate line GL1 and the second gate line GL2 extend in a first direction D1 and are arranged in a second direction D2, which differs from the first direction D1. The second direction D2 may be a vertical direction relative to the first direction D1, which may be a horizontal direction. The data lines DL1, DL2, DL3 and DL4 extend in the second direction D2 and are arranged in the first direction D1. The data lines DL1, DL2, DL3 and DL4 include a first data line DL1, a second data line DL2, a third data line DL3 and a fourth data line DL4, all of which cross the first gate line GL1 and the second gate line GL2. The first and second gate lines GL1 and GL2, and the first, second, third and fourth data lines DL1, DL2, DL3, and DL4 divide a first pixel region P1, a second pixel region P2 and a third pixel region P3.

The storage lines 121, 123, 125 and 127 include a first storage line 121, a second storage line 123, a third storage line 125, and a fourth storage line 127 extending in the second direction D2. The first, second, third and fourth storage lines 121, 123, 125 and 127 are connected to each other by a connecting line SL extending in the first direction D1. The connecting line SL may be disposed adjacent to the second gate line GL2. The first storage line 121 overlaps with the second data line DL2, the second storage line 123 overlaps with the third data line DL3, the third storage line 125 overlaps with the fourth data line DL4 and the fourth storage line 127 overlaps with the first data line DL1. The first, second, third and fourth storage lines 121, 123, 125 and 127 may be formed by patterning a gate metal layer forming the first and second gate lines GL1 and GL2. The first, second, third and fourth storage lines 121, 123, 125, and 127 may be wider than the first, second, third and fourth data lines DL1, DL2, DL3 and DL4.

The TFTs SW1, SW2 and SW3 include a first TFT SW1, a second TFT SW2 and a third TFT SW3, which are respectively connected to the first gate line GL1.

The first TFT SW1 includes a first gate electrode GE1, a first source electrode SE1, a first drain electrode DEL and a first active pattern 140a. The first TFT SW1 may be formed at a region where the first gate line GL1 and the second data line DL2 cross. The first gate electrode GE1 is connected to the first gate line GL1, and the first source electrode SE1 is connected to the second data line DL2. The first drain electrode DE1 is spaced apart from the first source electrode SE1. An edge portion of the first drain electrode DE1 extends in the first pixel region P1. A channel portion of the first TFT SW1 is defined by a spaced portion of the first source electrode SE1 and the first drain electrode DE1. The first active pattern 140a is formed under the first source electrode SE1 and the first drain electrode DE1. The first active pattern 140a may include a semiconductor layer 142, which may include amorphous silicon, and an ohmic contact layer 144, which may include amorphous silicon implanted with a high concentration of n⁺ impurities. The channel portion of the first TFT SW1 exposes the semiconductor layer 142 of the first active patter 140a.

Moreover, the second TFT SW2 may be formed at a region where the first gate line GL1 and the third data line DL3 cross. The second TFT SW2 includes a second gate electrode GE2 connected to the first gate line GL1, a second source electrode SE2 connected to the third data line DL3, a second drain electrode DE2 spaced apart from the second source electrode SE2 and a second active pattern (not shown) formed under the second source electrode SE2 and the second drain electrode DE2. An edge portion of the second drain electrode DE2 may extend in the second pixel region P2.

The third TFT SW3 may be formed at a region where the first gate line GL1 and the fourth data line DL4 cross. The third TFT SW3 includes a third gate electrode GE3 connected to the first gate line GL1, a third source electrode SE3 connected to the fourth data line DL4, a third drain electrode DE3 spaced apart from the third source electrode SE3 and a third active pattern 140c. An edge portion of the third drain electrode DE3 may extend in the third pixel region P3.

The first display substrate 101 may further include a gate insulation layer 130 and a passivation layer 160, formed on the first base substrate 110.

The gate insulation layer 130 is formed on the first base substrate 110 including the first and second gate lines GL1 and GL2, and the first, second and third gate electrodes GE1, GE2 and GE3. The first active pattern 140a, the second active pattern (not shown), and the third active pattern 140c are formed on the first base substrate 110 and the gate insulation layer 130.

The passivation layer 160 is formed on the first base substrate 110 including on the first, second, third and fourth data lines DL1, DL2, DL3 and DL4, the first, second and third source electrodes SE1, SE2 and SE3, and the first, second and third drain electrodes DE1, DE2 and DE3. The passivation layer 160 includes a plurality of contact holes respectively exposing the first, second and third drain electrodes DE1, DE2 and DE3.

The pixel electrodes 181, 183 and 185 include a first pixel electrode 181, a second pixel electrode 183 and a third pixel electrode 185. The first, second and third pixel electrodes 181, 183 and 185 are formed on the passivation layer 160.

The first pixel electrode 181 is formed on the first pixel region P1 and is electrically connected to the first TFT SW1. The first pixel electrode 181 contacts the first drain electrode DE1. The first pixel electrode 181 overlaps with the first storage line 121 and the fourth storage line 127.

A first main capacitor is defined by the first storage line 121 and the fourth storage line 127, which are overlapped with the first pixel electrode 181, and the gate insulation layer 130 and the passivation layer 160 interposed between the first storage line 121 and the first pixel electrode 181 and between the fourth storage line 127 and the first pixel electrode 181. Each of an overlapping width of the first storage line 121 with the first pixel electrode 181 and an overlapping width of the fourth storage line 127 with the first pixel electrode 181 is a first width (w1). Hereafter, a first area is defined as an overlapping area of the first storage line 121 with the first pixel electrode 181. An overlapping area the fourth storage line 121 with the first pixel electrode 181 may be substantially the same as the first area.

The second pixel electrode 183 is formed on the second pixel region P2 and electrically connected to the second TFT SW2. The second pixel electrode 183 contacts the second drain electrode DE2.

The second pixel electrode 183 overlaps with the first storage line 121 and the second storage line 123, thereby defining a second main capacitor. Each of an overlapping width of the first storage line 121 with the second pixel electrode 183 and an overlapping width of the second storage line 123 with the second pixel electrode 183 is the first width (w1). An overlapping area the first storage line 121 with the second pixel electrode 183 may be substantially the same as the first area, and an overlapping area the second storage line 123 with the second pixel electrode 183 may be substantially the same as the first area.

The third pixel electrode 185 is formed on the third pixel region P3 and electrically connected to the third TFT SW3. The third pixel electrode 185 contacts the third drain electrode DE3.

The third pixel electrode 185 overlaps with the second storage line 123 and the third storage line 125, thereby defining a third main capacitor. Each of an overlapping width of the second storage line 123 with the third pixel electrode 185 and an overlapping width of the third storage line 125 with the third pixel electrode 185 is the first width (w1). An overlapping area the second storage line 123 with the third pixel electrode 185 may be substantially the same as the first area, and an overlapping area the third storage line 125 with the third pixel electrode 185 may be substantially the same as the first area.

The first spacers 171 are respectively formed on the first, second and third TFTs SW1, SW2 and SW3. A first spacer 171 is formed on the channel portion of the first TFT SW1, a channel portion of the second TFT SW2 and a channel portion of the third TFT SW3.

The first spacers 171 may maintain a cell gap, which is a gap between the first display substrate 101 and the opposite substrate 200, of the first display apparatus 501. The first spacers 171 may serve as cell gap spacer maintaining the cell gap. The cell gap of the first display apparatus 501 may be about 3.5 μm to about 4.5 μm.

The first spacers 171 may insulate between the first, second and third TFTs SW1, SW2 and SW3 and the first, second and third capacitor electrodes 182, 184 and 186 formed on the first, second and third TFTs SW1, SW2 and SW3. The first spacers 171 may insulate between the capacitor electrodes 182, 184 and 186 and the semiconductor layer 142 of the first, second and third active patterns 140a and 140b. In an exemplary embodiment of the present invention, the first spacers 171 have substantially the same height as each other in the first display apparatus 501.

The capacitor electrodes 182, 184 and 186 are respectively formed on the first spacers 171 on the first, second and third TFTs SW1, SW2 and SW3. The capacitor electrodes 182, 184 and 186 define a plurality of sub-capacitors with a common electrode 240 of the opposite substrate 200. The sub-capacitor may charge electrons of the pixels with the first, second and third main capacitors.

The first capacitor electrode 182 is formed on the first spacer 171 formed on the first TFT SW1. The first capacitor electrode 182 is connected to the first pixel electrode 181. The first capacitor electrode 182 is insulated by the first spacer 171 from the first TFT SW1, and thus the generation of an off current in the first TFT SW1, generated by flow of the current into the first active pattern 140a, may be prevented.

Moreover, the second capacitor electrode 184 is formed on the first spacer 171 formed on the second TFT SW2. The second capacitor electrode 184 is connected to the second pixel electrode 183. The third capacitor electrode 186 is formed on the first spacer 171 formed on the third TFT SW3. The third capacitor electrode 186 is connected to the third pixel electrode 185.

The first alignment layer 190 is formed on an entire face of the first base substrate 110 having the first, second and third pixel electrodes 181, 183 and 185, the first, second and third capacitor electrodes 182, 184 and 186 and the first spacers 171.

The opposite substrate 200 includes a light-blocking pattern 220, a plurality of color filters 232, 234 and 236, the common electrode 240 and a second alignment layer 250 formed on a second base substrate 210 facing the first base substrate 110.

The light-blocking pattern 220 is formed on a region of the second base substrate 210. The region corresponds with the first and second gate lines GL1 and GL2 and the first, the second, the third and the fourth data lines DL1, DL2, DL3 and DL4. The light-blocking pattern 220 may be formed on a region of the second base substrate 210 that corresponds with the first, second and third TFTs SW1, SW2 and SW3. The second base substrate 210 may be divided by the light-blocking pattern 220 to define the first, second and third pixel regions P1, P2 and P3.

The color filters include a first color filter 232 formed on the first pixel region P1, a second color filter 234 formed on the second pixel region P2 and a third color filter 236 formed on the third pixel region P3. For example, the first color filter 232 may represent red, the second color filter 234 may represent green, and the third color filter 236 may represent blue.

The common electrode 240 is formed on the second base substrate 210 including the light-blocking pattern 220, and the first, second and third color filters 232, 234 and 236. The common electrode 240 is formed on an entire face of the second base substrate 210.

An overcoating layer, not shown, may be formed between the second base substrate 210 including the light-blocking pattern 220, the first, second and third color filters 232, 234 and 236 and the common electrode 240.

The second alignment layer 250 is formed on the common electrode 240. The second alignment layer 250 opposes and contacts the first alignment layer 190 after the first display substrate 101 is combined with the opposite substrate 200.

The liquid crystal layer 300 is interposed between the first display substrate 101 and the opposite substrate 200. The liquid crystal layer 300 includes a plurality of liquid crystal molecules interposed between the first display substrate 101 and the opposite substrate 200. The liquid crystal molecules are disposed between the first alignment layer 190 and the second alignment layer 250.

A first sub-capacitor is defined by the common electrode 240 and the first capacitor electrode 182. The capacitor includes two electrodes facing each other and a dielectric substance interposed between the two electrodes, where the first capacitor electrode 182 serves as one electrode, the common electrode 240 serves as the second electrode, and the first alignment layer 190 and the second alignment layer 250 serve as the dielectric substance. The first sub-capacitor serves as a capacitor of the first pixel region P1 with the first main capacitor. The first sub-capacitor may charge electrons of the first pixel region P1 into the first alignment layer 190 and the second alignment layer 250 interposed between the first capacitor electrode 182 and the common electrode 240.

Moreover, a second sub-capacitor is defined by the common electrode 240 and the second capacitor electrode 184. The second sub-capacitor may charge electrons of the second pixel region P2 with the second main capacitor. A third sub-capacitor is defined by the common electrode 240 and the third capacitor electrode 186. The third sub-capacitor may charge electrons of the third pixel region P3 with the third main capacitor. The second and third sub-capacitors are substantially the same as the first sub-capacitor except for their location. Thus, any further description of the second and third sub-capacitors will be omitted.

The electric capacity of the first main capacitor may be decreased by charging some electrons in the first pixel electrode 181 into the first sub-capacitor, compared with charging all of the electrons in the first pixel electrode 181 into the first main capacitor. In other words, widths of the first storage line 121 and the fourth storage line 127 may be decreased, compared with charging all of the electrons in the first pixel electrode 181 into the first main capacitor. Moreover, widths of the second storage line 123 and the third storage line 125 may be decreased, compared with charging all of the electrons into each of the second pixel electrode 183 and the third pixel electrode 185. According to a decrease in the widths of the first, second, third and fourth storage lines 121, 123, 125 and 127, the apertures of the first display apparatus 501 may increase, and thus the aperture ratio of the first display apparatus 501 may be improved. Thus, the brightness of the first display apparatus 501 may be improved and the display quality of the first display apparatus 501 may be improved.

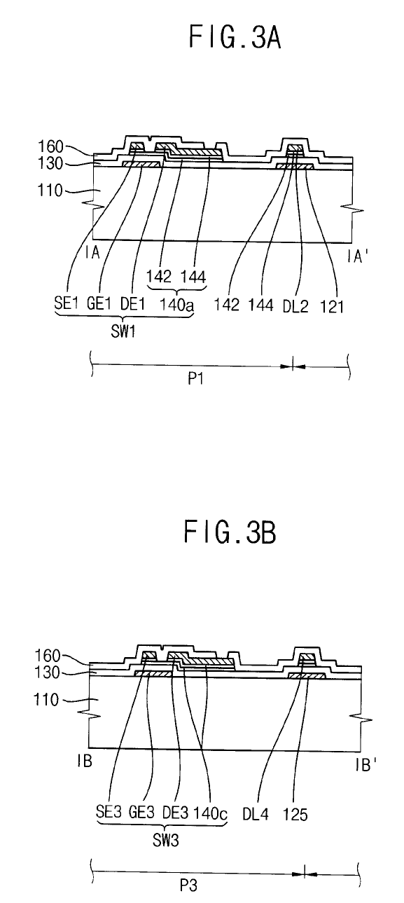

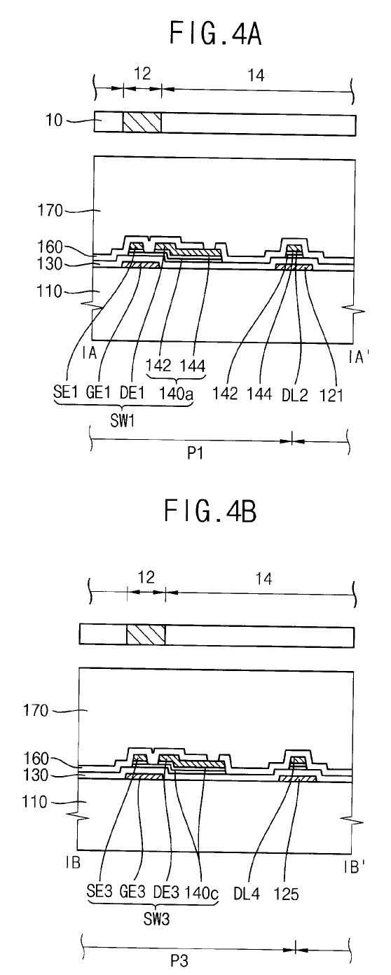

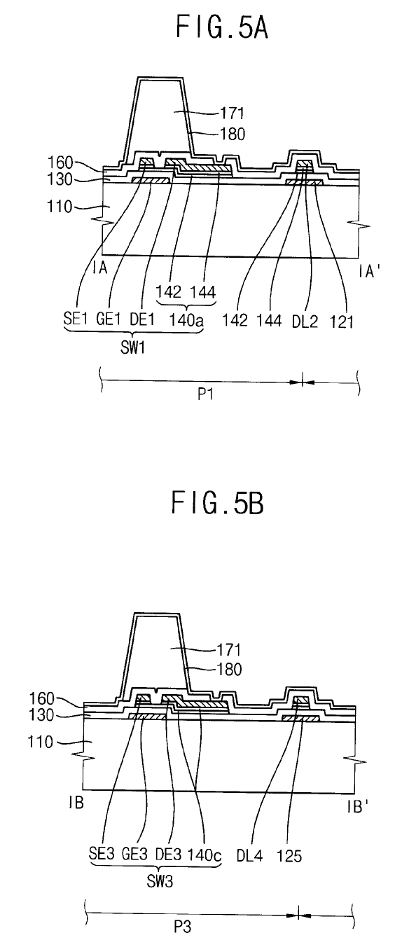

Hereafter, a method of manufacturing the display apparatus shown in FIG. 1, FIG. 2A and FIG. 2B will be described referring to FIG. 3A, FIG. 3B, FIG. 4A, FIG. 4B, FIG. 5A, FIG. 5B, FIG. 6A and FIG. 6B. In the method of manufacturing the display apparatus, a process of manufacturing the opposite substrate will be described referring to FIG. 2A and FIG. 2B.

FIG. 3A, FIG. 4A, FIG. 5A and FIG. 6A are cross-sectional views illustrating a method of manufacturing the pixel region shown in FIG. 2A, and FIG. 3B, FIG. 4B, FIG. 5B and FIG. 6B are cross-sectional views illustrating a method of manufacturing the pixel region shown in FIG. 2B. FIG. 3A, FIG. 4A, FIG. 5A and FIG. 6A are cross-sectional views of the first pixel region of the display apparatus, and FIG. 3B, FIG. 4B, FIG. 5B and FIG. 6B are cross-sectional views of the third pixel region of the display apparatus.

FIG. 3A and FIG. 3B are cross-sectional views illustrating a step of forming the TFTs SW1, SW2 and SW3 connected to the signal lines GL1, GL2, DL1, DL2, DL3 and DL4 on the first base substrate 110.

Referring to FIG. 3A and FIG. 3B, a gate metal layer (not shown) is formed on the first base substrate 110, and the gate metal layer is patterned by a photolithography process to form the first and second gate lines GL1 and GL2, the first, second, third and fourth storage electrode lines 121, 123, 125 and 127, and the first, second and third gate electrodes GE1, GE2 and GE3.

The gate insulation layer 130 is formed on the first base substrate 110 including the first and second gate lines GL1 and GL2, the first, second, third and fourth storage electrode lines 121, 123, 125 and 127, and the first, second and third gate electrodes GE1, GE2 and GE3. Examples of a material that may be used for the gate insulation layer 130 are silicon nitride, silicon oxide, etc.

The semiconductor layer 142, the ohmic contact layer 144, and a source metal layer (not shown) are formed on the first base substrate 110 including the gate insulation layer 130. The semiconductor layer 142, the ohmic contact layer 144 and the source metal layer are patterned by a photolithography process using only one mask to form the first active pattern 140a, the second active pattern (not shown), and the third active pattern 140c, the first, second, third and fourth data lines DL1, DL2, DL3 and DL4, the first, second and third source electrodes SE1, SE2 and SE3, and the first, second and third drain electrodes DE1, DE2 and DE3. Thus, the semiconductor layer 142 and the ohmic contact layer 144 may remain under the first, second, third and fourth data lines DL1, DL2, DL3 and DL4.

The passivation layer 160 is formed on the first base substrate 110. The passivation layer 160 is patterned to form the contact holes exposing edge portions of the first, second and third drain electrodes DE 1, DE2 and DE3. Examples of materials that may be used for the passivation layer 160 are silicon nitride, silicon oxide, etc.

In one embodiment, the semiconductor layer 142 and the ohmic contact layer 144 are patterned using a first mask to form the first active pattern 140a, the second active pattern (not shown), and the third active pattern 140c. Then, the source metal layer is formed on the first base substrate 110 including the first active pattern 140a, the second active pattern (not shown), and the third active pattern 140c, and the source metal layer is patterned using a second mask to form the first, second, third and fourth data lines DL1, DL2, DL3 and DL4, the first, second and third source electrodes SE1, SE2 and SE3, and the first, second and third drain electrodes DE1, DE2 and DE3. In this case, the semiconductor layer 142 and the ohmic contact layer 144 may not remain under the first, second, third and fourth data lines DL1, DL2, DL3 and DL4.

FIG. 4A and FIG. 4B are cross-sectional views illustrating a process of forming the first spacers 171 on the first base substrate 110 including the first, second and third TFTs SW1, SW2 and SW3.

Referring to FIG. 4A and FIG. 4B, a photosensitive organic layer 170 is formed on the first base substrate 110 including the first, second and third TFTs SW1, SW2 and SW3. An example of a material that may be used for the photosensitive organic layer 170 is a positive-type photoresist composition.

A first mask 10 is disposed over the first base substrate 110 including the photosensitive organic layer 170. The first mask 10 includes a light-blocking portion 12 blocking the light provided on the first base substrate 110 and a transmitting portion 14 transmitting the light. The light-blocking portion 12 of the first mask 10 is disposed over the first, second and third TFTs SW1, SW2 and SW3. The transmitting portion 14 of the first mask 10 is disposed over the remaining regions except for the regions including the first, second and third TFTs SW1, SW2 and SW3.

The photosensitive organic layer 170 is exposed with light and developed by a developing solution. Thus, the photosensitive organic layer 170 on the first, second and third TFTs SW1, SW2 and SW3 remains on the first base substrate 110 and the photosensitive organic layer 170 on the other regions is removed by the developing solution.

In some embodiments, the photosensitive organic layer 170 may be formed using a negative-type photoresist composition. The light-blocking portion 12 and the transmitting portion 14 of the first mask 10 may be reversed. Thus, portions of the photosensitive organic layer 170 irradiated with light may remain on the first base substrate 110, and portions of the photosensitive organic layer 170 that are not irradiated with light may be removed.

FIG. 5A and FIG. 5B are cross-sectional views illustrating a process of forming the first, second and third pixel electrodes 181, 183 and 185 and the first, second and third capacitor electrodes 182, 184 and 186 on the first base substrate 110 including the first spacers 171.

In FIG. 5A and FIG. 5B, the photosensitive organic layer 170 is developed, thereby forming the first spacers 171 on the first, second and third TFTs SW1, SW2 and SW3. The first spacers 171 are respectively formed on the channel portions of the first, second and third TFTs SW1, SW2 and SW3. Heights of the first spacers 171 may be substantially the same as each other.

A transparent electrode layer 180 is formed on the first base substrate 110 including the first spacer 171. Examples of materials that may be used for the transparent electrode layer 180 are indium tin oxide, indium zinc oxide, etc.

The transparent electrode layer 180 is patterned by a photolithography process to form the first, second and third pixel electrodes 181, 183 and 185 and the first, second and third capacitor electrodes 182, 184 and 186. The first pixel electrode 181 is connected to the first capacitor electrode 182, the second pixel electrode 183 is connected to the second capacitor electrode 184, and the third pixel electrode 185 is connected to the third capacitor electrode 186.

FIG. 6A and FIG. 6B are cross-sectional views illustrating a process of forming the first alignment layer 190 on the first base substrate 110 including the first, second and third pixel electrodes 181, 183 and 185 and the first, second and third capacitor electrodes 182, 184 and 186.

Referring to FIG. 6A and FIG. 6B, the first alignment layer 190 is formed on the first base substrate 110 including the first, second and third pixel electrodes 181, 183 and 185 and the first, second and third capacitor electrodes 182, 184 and 186.

An example of a material that may be used for the first alignment layer 190 is an organic material including polyimide compound. The organic material is coated on the first base substrate 110, including the first, second and third pixel electrodes 181, 183 and 185 and the first, second and third capacitor electrodes 182, 184 and 186, to form a preparation layer. The preparation layer is rubbed by a rubbing cloth to form the first alignment layer 190. In some embodiments, an organic material having a photosensitivity is coated on the first base substrate 110 and light is provided to the organic material to form the first alignment layer 190.

Referring to FIG. 2A and FIG. 2B, in the process of forming the opposite substrate 200, the light-blocking pattern 220 is formed on the second base substrate 210.

In one embodiment, a metal layer (not shown) may be formed on the second base substrate 210 and patterned by a photolithography process to form the light-blocking pattern 220. The metal layer may include chromium, chromium/chromium oxide, etc. In some embodiments, the light-blocking pattern 220 may be formed by jetting an organic ink on the second base substrate 210.

In one embodiment, the color filters 232, 234 and 236 are formed on the second base substrate 210 including the light-blocking pattern 220. The color filters 232, 234 and 236 are formed by patterning a color photoresist layer (not shown), which is formed on the second base substrate 210, through a photolithography process. In some embodiments, the color filters 232, 234 and 236 may be formed by jetting a color ink on the second base substrate 210.

The common electrode 240 is formed on the second base substrate 210 including the light-blocking pattern 220 and the color filters 232, 234 and 236. Examples of materials that may be used for the common electrode 240 are indium tin oxide, indium zinc oxide, etc. The second alignment layer 250 is formed on the second base substrate 210 including the common electrode 240. A process of forming the second alignment layer 250 is substantially the same as the process of forming the first alignment layer 190. Thus, any further description will be omitted.

The first display substrate 101 is combined with the opposite substrate 200. The first spacers 171 are interposed between the first display substrate 101 and the opposite substrate 200. The first alignment layer 190 disposed on the first spacer 171 contacts the second alignment layer 250 of the opposite substrate 200. The first spacers 171 may serve as cell gap spacers maintaining the cell gap between the first display substrate 101 and the opposite substrate 200.

The liquid crystal molecules may be injected into the first display apparatus 501 to form the liquid crystal layer 300, and a driving part (not shown), which drives components on the first display substrate 101 and the opposite substrate 200, is combined with the first display substrate 101, thereby manufacturing the first display apparatus 501.

According to an exemplary embodiment of the present invention, an organic layer, formed on the passivation layer 160 and planarizing the first display substrate 101, is omitted. The first, second and third sub-capacitors are formed using the first spacers 171. Thus, processes of manufacturing the first display apparatus may be simple, and thus the productivity of the first display apparatus may be improved. Moreover, the aperture ratio may be improved by the first, second and third sub-capacitors and the display quality may be improved.

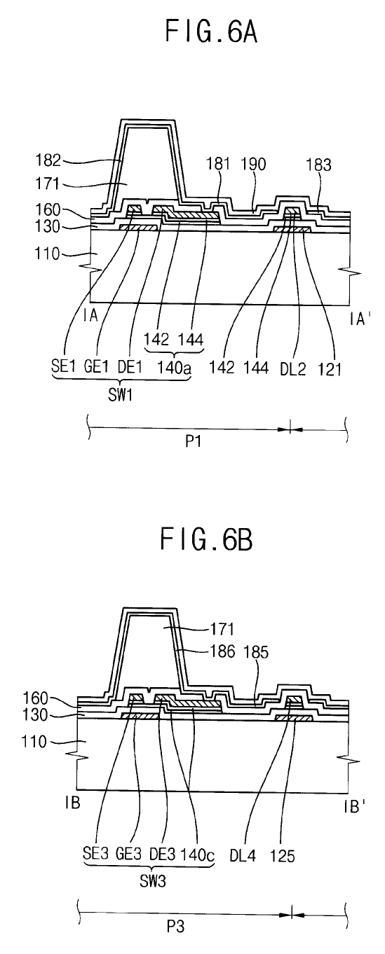

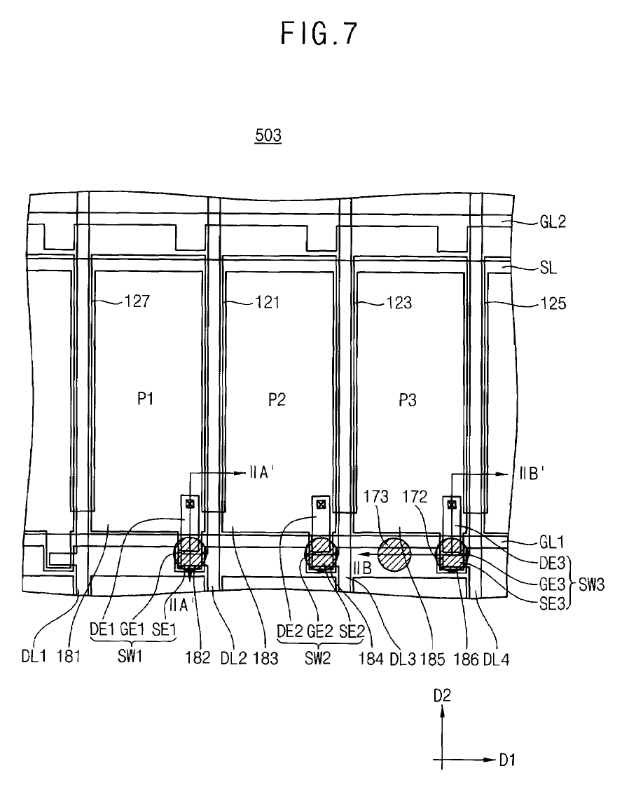

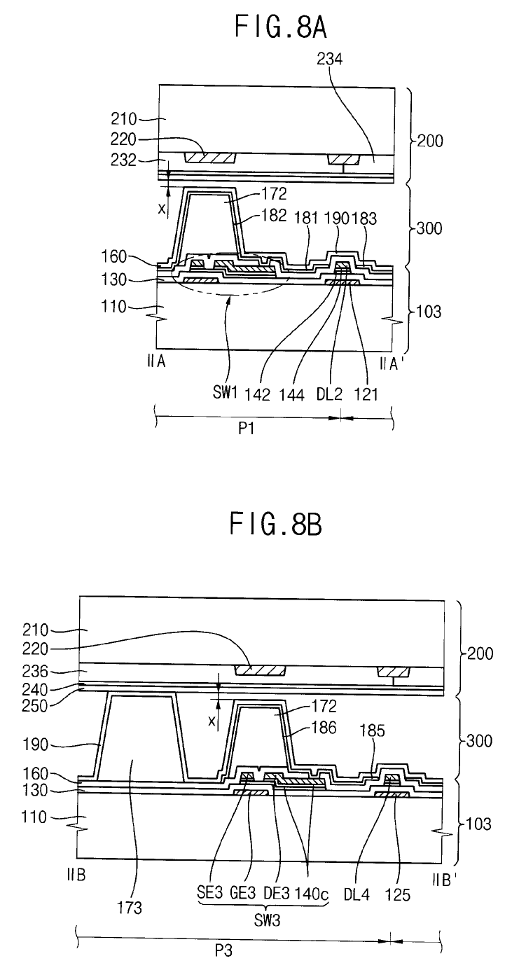

Hereinafter, a display substrate and display apparatus according to a second exemplary embodiment of the present invention will be described with reference to FIG. 7, FIG. 8A and FIG. 8B. FIG. 7 is a plan view illustrating a display apparatus in accordance with a second embodiment of the present invention, and FIG. 8A and FIG. 8B are cross-sectional views along lines IIA-IIA′ and IIB-IIB′, respectively, of FIG. 7.

In FIG. 7, FIG. 8A and FIG. 8B, a second display apparatus in accordance with a second exemplary embodiment of the present invention is substantially the same as the first display apparatus in accordance with the first exemplary embodiment of the present invention shown in FIG. 1, FIG. 2A and FIG. 2B, except for a second pixel region including a second spacer and a third spacer. Moreover, the second pixel region is substantially the same as the first pixel region, except for the second spacer and the third spacer. Thus, any further description will be omitted.

Referring to FIG. 7, FIG. 8A and FIG. 8B, the second display apparatus 503 in accordance with a second exemplary embodiment of the present invention includes a second display substrate 103, an opposite substrate 200 and a liquid crystal layer 300.

The second display substrate 103 includes a plurality of the second spacers 172 formed on a first TFT SW1, a second TFT SW2 and a third TFT SW3 and the third spacer 173 formed on a first gate line GL1 and a region adjacent to the first gate line GL1.

A first capacitor electrode 182 connected to a first pixel electrode 181 and a first alignment layer 190 are formed on the second spacer 172 disposed on the first TFT SW1. A second capacitor electrode 184 and the first alignment layer 190 are formed on the second spacer 182 disposed on the second TFT SW2. A third capacitor electrode 186 and the first alignment layer 190 are formed on the second spacer 182 disposed on the third TFT SW3. The first alignment layer 190 formed on the second spacer 172 is spaced apart from the second alignment layer 250. A distance between the first alignment layer 190 formed on the second spacer 172 and the second alignment layer 250 may be a first distance (x).

A first sub-capacitor is defined by the first capacitor electrode 182, a common electrode 240 of the opposite substrate 200, the first alignment layer 190, the second alignment layer 250 and liquid crystal molecules. Further, a second sub-capacitor is defined by the second capacitor electrode 184, the common electrode 240, the first alignment layer 190, the second alignment layer 250 and the liquid crystal molecules. Further moreover, a third sub-capacitor is defined by the third capacitor electrode 186, the common electrode 240, the first alignment layer 190, the second alignment layer 250 and the liquid crystal molecules.

When outer pressure is provided to the second display apparatus 503, the second spacers 172 may constantly maintain the distance between the second display substrate 103 and the opposite substrate 200.

In determining electric capacities of the first, second and third sub-capacitors, when the areas of the first, second and third capacitor electrodes 182, 184 and 186 are constant, the larger the first distance (x), the less the electric capacity is. Also, the smaller the first distance (x), the greater the electric capacity is. In other words, the first distance (x) is inversely proportional to the electric capacity.

The first distance (x) may be 0<x≦1.0 μm. The first distance (x) may be about 0.3 μm, considering the process margin in a combining process between the second display substrate 103 and the opposite substrate 200 and/or a forming process of the second spacers 172.

The first alignment layer 190 is formed on and contacts the third spacer 173. The first alignment layer 190 formed on the third spacer 173 contacts the second alignment layer 250. The third spacer 173 may serve as a cell gap spacer maintaining a distance between the second display substrate 103 and the opposite substrate 200. An area of a light transmittance region may be decreased because of forming the third spacer 173 and thus, the third spacer 173 may be formed in an insensitive region in changing the brightness. For example, the third spacer 173 is formed adjacent to the third pixel region P3 including a blue color filter 236 in the first, second and third pixel regions P1, P2 and P3. The top surface of the third spacer 173 is higher than the top surface of the second spacer 172. The difference between the heights of the top surfaces of the third spacer 173 and the second spacer 172 may be substantially the same as the first distance (x). In other words, the top surface of the third spacer 173 may be higher than the top surface of the second spacer 172 by as much as the first distance (x).

According to the second exemplary embodiment of the present invention, the electric capacity of the first main capacitor may be decreased by charging some of the electrons in the first pixel electrode 181 into the first sub-capacitor, comparing with charging all of the electrons in the first pixel electrode 181 into the first main capacitor. In other words, widths of the first storage line 121 and the fourth storage line 127 may be decreased, comparing with charging entire electrons in the first pixel electrode 181 into the first main capacitor. Moreover, widths of the second storage line 123 and the third storage line 125 may be decreased, comparing with charging all of the electrons into each of the second pixel electrode 183 and the third pixel electrode 185. According to decreasing the widths of the first, second, third and fourth storage lines 121, 123, 125 and 127, the apertures of the second display apparatus 503 may increase, and thus the aperture ratio of the second display apparatus 503 may be improved. Thus, the brightness of the second display apparatus 503 may be improved and the display quality of the second display apparatus 503 may be improved.

Moreover, because the first alignment layer 190 formed on the second spacer 172 does not make contact with the second alignment layer 250, and the third spacer 173 constantly maintains the cell gap, a contact area of the second spacers 172 and the opposite substrate 200 may be decreased. Thus, the margin of dropping liquid crystal molecules between the second display substrate 103 and the opposite substrate 200 may be improved.

Hereafter, a method of manufacturing the second pixel region in accordance with the second exemplary embodiment will be described. In the method of manufacturing the second pixel region in accordance with the second exemplary embodiment, a process of forming the first, second and third TFTs SW1, SW2 and SW3 is substantially the same as the process of forming the first, second and third TFTs SW1, SW2 and SW3 in accordance with the first exemplary embodiment of the present invention. Thus, any further description will be omitted.

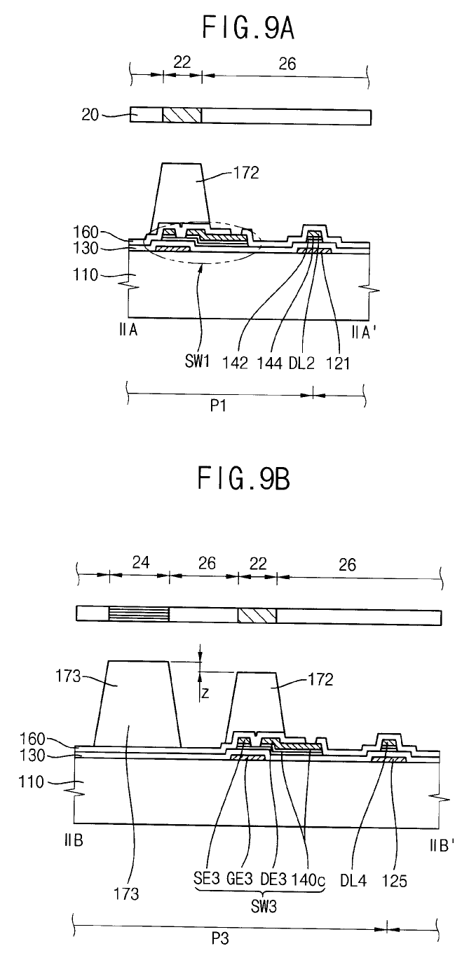

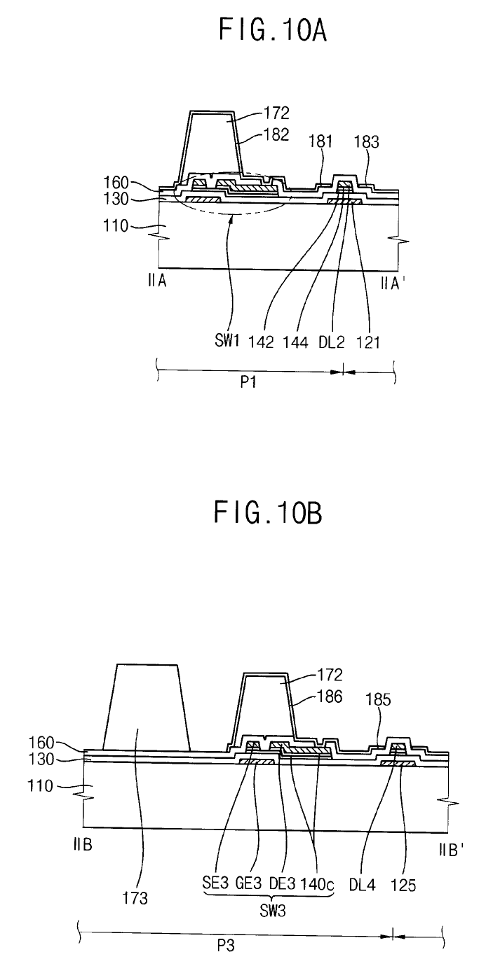

FIG. 9A and FIG. 10A are cross-sectional views illustrating a method of manufacturing a pixel region shown in FIG. 8A, and FIG. 9B and FIG. 10B are cross-sectional views illustrating a method of manufacturing a pixel region shown in FIG. 8B.

Referring to FIG. 9A and FIG. 9B, a passivation layer 160 is formed on the first base substrate 110 including the first, second and third TFTs SW1, SW2 and SW3. A photosensitive organic layer (not shown) is formed on the passivation layer 160. For example, the photosensitive organic layer may include a positive-type photoresist composition.

A second mask 20 is disposed over the first base substrate 110 including the photosensitive organic layer. The second mask 20 includes a first region 22 partially transmitting light, a second region 24 blocking the light and a third region 26 entirely transmitting light. In one embodiment, the second mask 20 may be a slit mask in which the first region 22 includes a plurality of slits. In some embodiments, the second mask 20 may be a halftone mask in which the first region 22 includes a semi-transmitting layer.

An intensity of light (y) transmitting through the first region 22 may be 0<y<100 when an intensity of light transmitting through the third region 26 defines “100”. The intensity of light (y) transmitting through the first region 22 may be 50<y<100. In some embodiments, the intensity of light (y) transmitting through the first region 22 may be 80<y<100.

The photosensitive organic layer is exposed to light and developed by a developing solution. Thus, the photosensitive organic layer 170 corresponding to the first region 22 partially remains on the first base substrate 110 to form the second spacers 172 on the first, second and third TFTs SW1, SW2 and SW3, and the photosensitive organic layer 170 corresponding the second region 24 entirely remains to form the third spacer 173, higher than the second spacers 172. A top surface of the third spacer 173 is higher than a top surface of the second spacer 172. The difference between the heights of the top surfaces of the third spacer 173 and the second spacer 172 may be a second distance (z). The second distance (z) may be 0<z≦1.0 μm. A range of the second distance (z) may be substantially the same as a range of the first distance (x).

Referring to FIG. 10A and FIG. 10B, a transparent electrode layer (not shown) is formed on the first base substrate 110 including the second spacers 172 and the third spacer 173. The transparent electrode layer is patterned by a photolithography process to form the first, second and third pixel electrodes 181, 183 and 185 and the first, second and third capacitor electrodes 182, 184 and 186. Each of the first, second and third pixel electrodes 181, 183 and 185 are formed on the passivation layer 160 in each of the first, second and third pixel regions P1, P2 and P3. Each of the first, second and third capacitor electrodes 182, 184 and 186 is formed on each of the second spacers 172. The transparent electrode layer on the third spacer 173 is removed.

The first alignment layer 190 is formed on the first base substrate 110 including the first, second and third pixel electrodes 181, 183 and 185 and the first, second and third capacitor electrodes 182, 184 and 186. The second display substrate 103 is combined with the opposite substrate 200 including the common electrode 240 and the second alignment layer 250 formed on a second base substrate 210 including a light-blocking pattern 220 and color filters 232, 234 and 236.

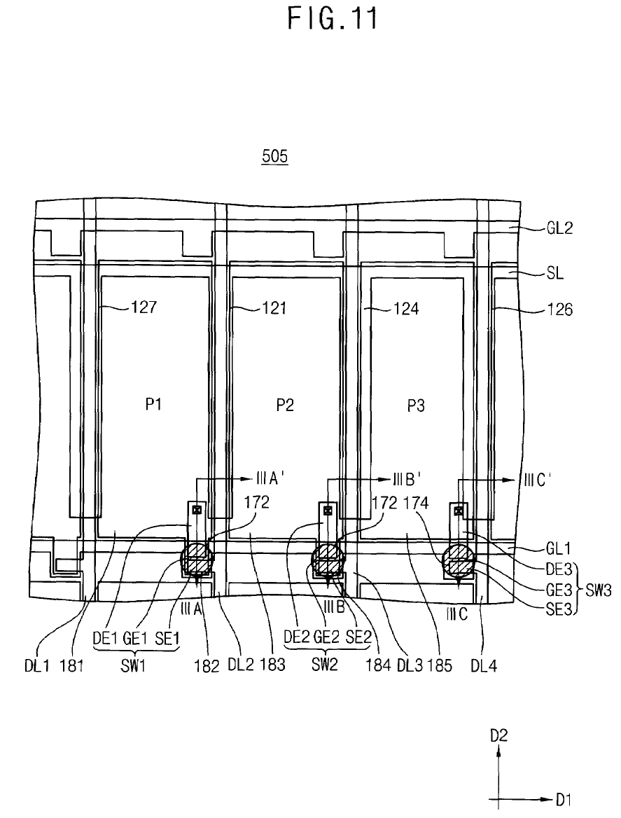

Hereinafter, a display substrate and display apparatus according to a third exemplary embodiment of the present invention will be described with reference to FIG. 11. FIG. 11 is a plan view illustrating a display apparatus in accordance with a third exemplary embodiment of the present invention.

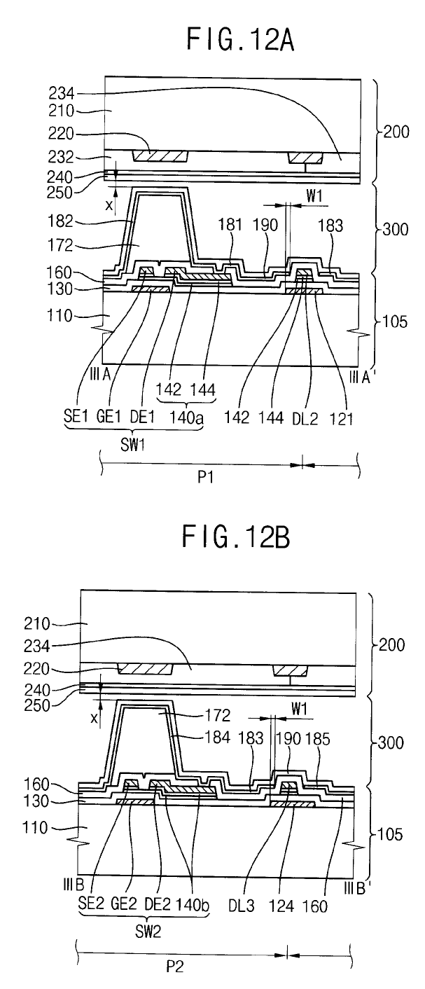

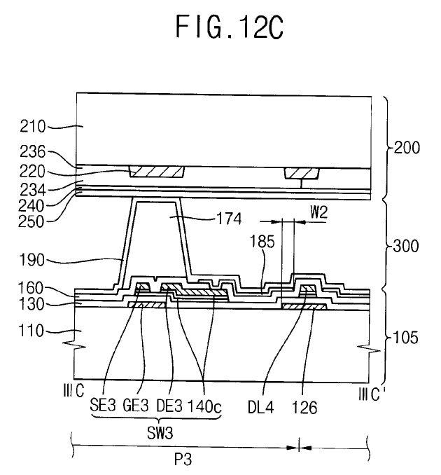

FIG. 12A, FIG. 12B and FIG. 12C are cross-sectional views along lines IIIA-IIIA′, IIIB-IIIB′ and IIIC-IIIC′ respectively, of FIG. 11.

In FIG. 11, FIG. 12A, FIG. 12B and FIG. 12C, a third display apparatus in accordance with the third exemplary embodiment of the present invention is substantially the same as the first display apparatus in accordance with the first exemplary embodiment of the present invention shown in FIG. 1, FIG. 2A and FIG. 2B, except for a third pixel region. Moreover, the third pixel region is substantially the same as the first pixel region, except for the first spacer and the third capacitor electrode of the first exemplary embodiment. Thus, any further description will be omitted.

Referring to FIG. 11, FIG. 12A, FIG. 12B and FIG. 12C, a third display apparatus 505 includes a third display substrate 105, an opposite substrate 200 and a liquid crystal layer 300.

The third display substrate 105 includes a plurality of second spacers 172 formed on each of a first TFT SW1 and a second TFT SW2 and a fourth spacer 174 formed on a third TFT SW3.

A first capacitor electrode 182 connected to a first pixel electrode 181, the second spacer 172 and a first alignment layer 190 are formed on the first TFT SW1. A second capacitor electrode 184 connected to a second pixel electrode 183, the second spacer 172 and the first alignment layer 190 are formed on the second TFT SW2. The first alignment layer 190 formed on the second spacer 172 is spaced apart from a second alignment layer 250 of the opposite substrate 200, as much as a first distance (x). The first distance (x) may be 0<x≦1.0 μm.

By forming a first sub-capacitor including the first capacitor electrode 182 and a common electrode 240 of the opposite substrate 200 and a second sub-capacitor including the second capacitor electrode 184 and the common electrode 240, a first width (w1) may be decreased, which is the first storage line 121 overlapped with the first pixel electrode 181 or the fourth storage line 127 overlapped with the first pixel electrode 181. Moreover, a first width (w1) may be decreased, which is a fifth storage line 124 overlapped with the second pixel electrode 183 or the sixth storage line 126 overlapped with the third pixel electrode 185. The fifth storage line 124 is formed under a third data line DL3, and the sixth storage line 126 is formed under a fourth data line DL4.

The fourth spacer 174 is formed on the passivation layer 160 disposed on the third TFT SW3. The fourth spacer 174 may make contact the passivation layer 160. The first alignment layer 190 is formed on the fourth spacer 174. The alignment layer 190 formed on the fourth spacer 174 contacts with the second alignment layer 250. The fourth spacer 174 may serve as a cell gap spacer maintaining a distance between the third display substrate 105 and the opposite substrate 200. When a first area is an overlapping area of the first storage line 121 with the first pixel electrode 181, each of an overlapping area of the first storage line 121 and the second pixel electrode 183 and an overlapping area of the fifth storage line 124 with the second pixel electrode 183 may be the first area.

An overlapping area overlapped the fifth storage line 124 with the third pixel electrode 185 is a second area. The second area is wider than the first area. An area of the sixth storage line 126 overlapped with the third pixel electrode 185 is the second area. The fifth storage line 124 and the sixth storage line 126 are overlapped with the third pixel electrode 185 as much as a second width (w2). The second width (w2) is wider than a first width (w1), where the first storage line 121 overlaps with the first pixel electrode 181. The first storage line 121 may be narrower than the fifth storage line 124 and the sixth storage line 126. The aperture ratio of a third pixel region P3 may not be changed, and the third pixel region P3 may be affected to increase brightness or/and decrease brightness. Thus, only the aperture ratios of a first pixel region P1 and a second pixel region P2 may be increased and the brightness may be improved, and thus the aperture ratio of the fourth display apparatus 507 may be increased and the brightness of the fourth display apparatus 507 improved.

A method of manufacturing the third display substrate in accordance with the third exemplary embodiment of the present invention is substantially the same as the method of manufacturing the first substrate shown in FIG. 2A, FIG. 2B, FIG. 3A, FIG. 3B, FIG. 4A, FIG. 4B, FIG. 5A, FIG. 5B, FIG. 6A and FIG. 6B, except for forming the first, second and third pixel electrodes, the first and second capacitor electrodes and forming the second and the fourth spacers. Thus, any further description will be omitted.

In the method of manufacturing the third display substrate in accordance with the third exemplary embodiment of the present invention, a passivation layer 160 is formed on the first base substrate 110 including the first, second and third TFTs SW1, SW2 and SW3. A photosensitive organic layer (not shown) is formed on the passivation layer 160 and is patterned using a third mask to form the second spacer 172 and the fourth spacer 174.

The third mask includes a fourth region corresponding to the first and second TFTs SW1 and SW2 and a fifth region corresponding to the third TFT SW3. When the photosensitive organic layer includes a positive-type photoresist composition, the fourth region may be a semi-transmitting portion and the fifth region may be a light-blocking portion. A transparent electrode layer is formed on the first base substrate 110, and then is patterned to form the first, second and third pixel electrodes 181, 183 and 185, the first and second capacitor electrodes 182 and 184.

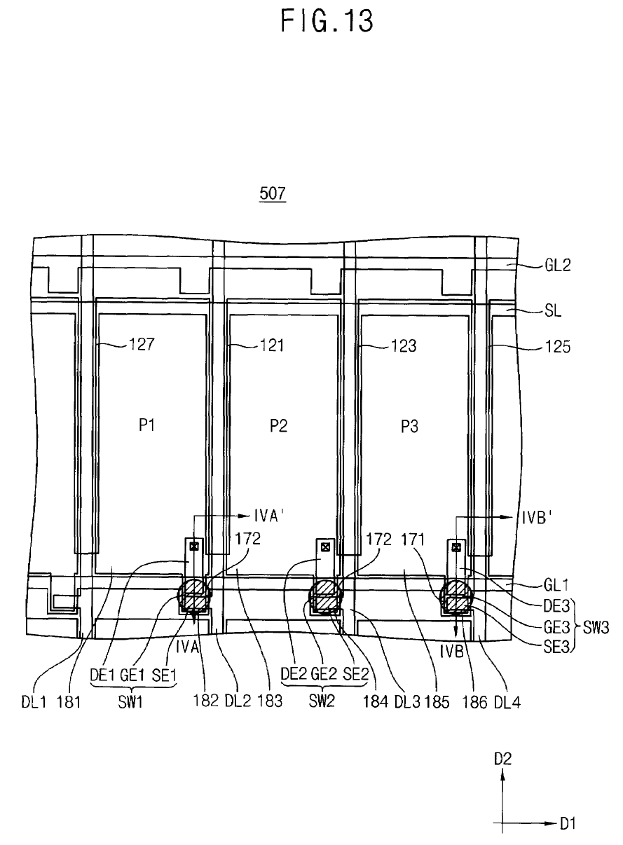

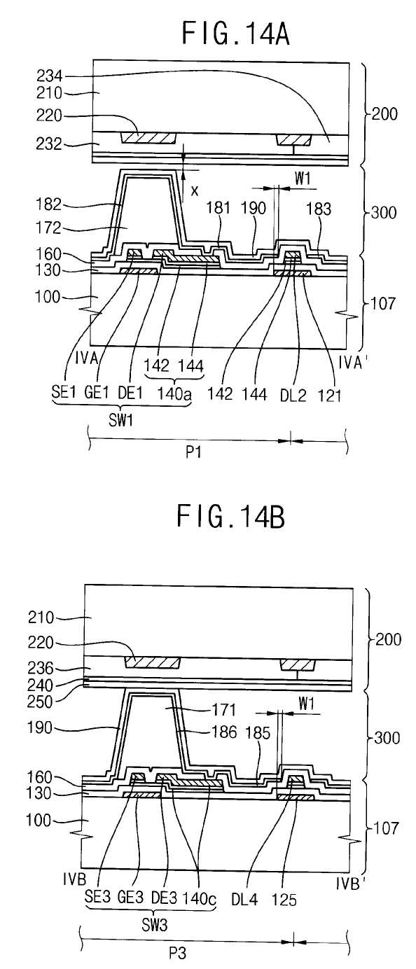

Hereinafter, a display substrate and display apparatus according to a fourth exemplary embodiment of the present invention will be described with reference to FIG. 13. FIG. 13 is a plan view illustrating a display apparatus in accordance with a fourth embodiment of the present invention, and FIG. 14A and FIG. 14B are cross-sectional views along lines IVA-IVA′ and IVB-IVB′, respectively, of FIG. 13.

In FIG. 13, FIG. 14A and FIG. 14B, a fourth display apparatus in accordance with a fourth exemplary embodiment of the present invention is substantially the same as the second display apparatus in accordance with the second exemplary embodiment of the present invention, except for a first spacer formed on a third TFT and a first capacitor electrode. Thus, any further description will be omitted.

Referring to FIG. 13, FIG. 14A and FIG. 14B, the fourth display apparatus 507 in accordance with a fourth exemplary embodiment of the present invention includes a fourth display substrate 107, an opposite substrate 200 and a liquid crystal layer 300.

The fourth display substrate 107 includes a plurality of second spacers 172 formed on a first TFT SW1 and a second TFT SW2 and a plurality of first spacers 171 formed on a third TFT SW3. The first spacers 171 may serve as a cell gap spacer. The fourth display substrate 107 further includes a first capacitor electrode 182 formed on the second spacer 172 disposed on the first TFT SW1, a second capacitor electrode 184 formed on the second spacer 172 disposed on the second SW2, and a third capacitor electrode 186 formed on the first spacer 171 disposed on the third TFT SW3. The first capacitor electrode 182 is connected to a first pixel electrode 181, the second capacitor electrode 184 is connected to a second pixel electrode 183, and the third capacitor electrode 186 is connected to a third pixel electrode 185. The second spacer 172 may be lower than the first spacer 171. Thus, a first alignment layer 190 formed on the first and second capacitor electrodes 182 and 184 is spaced apart from a second alignment layer 250 as much as a first distance (x). The first alignment layer 190 formed on the third capacitor electrode 186 contacts the second alignment layer 250.

A first sub-capacitor is defined by the first capacitor electrode 182, a common electrode 240 of the opposite substrate 200, the first alignment layer 190 and the second alignment layer 250 interposed between the first capacitor electrode 182 and the common electrode 240, and liquid crystal molecules. A first width, where the first storage line 121 overlaps with the first pixel electrode 181 and the fourth storage line 127 overlaps with the first pixel electrode 181, may be decreased, and thus the aperture ratio of the first pixel region P1 may be improved.

Moreover, the aperture ratio of a second pixel region P2 may be improved by forming a second sub-capacitor including a second capacitor electrode 184 and the common electrode 240. Further, the aperture ratio of a third pixel region P3 may be improved by forming a third sub-capacitor including a third capacitor electrode 186 and the common electrode 240. The third sub-capacitor may also comprise the first spacer 171. The first spacer 171 may maintain a distance between the third display substrate 107 and the opposite substrate 200.

A method of manufacturing the fourth display substrate in accordance with a fourth exemplary embodiment of the present invention is substantially the same as the method of manufacturing the first substrate shown in FIG. 2A, FIG. 2B, FIG. 3A, FIG. 3B, FIG. 4A, FIG. 4B, FIG. 5A, FIG. 5B, FIG. 6A and FIG. 6B, except for forming the first and second spacers. Thus, any further description will be omitted.

In the method of manufacturing the fourth display substrate in accordance with a fourth exemplary embodiment of the present invention, a passivation layer 160 is formed on the first base substrate 110 including the first, second and third TFTs SW1, SW2 and SW3. A photosensitive organic layer (not shown) is formed on the passivation layer 160 and is patterned using a fourth mask to form the first spacer 171 and the second spacer 172.

The fourth mask includes a sixth region corresponding to the first and second TFTs SW1 and SW2 and a seventh region corresponding to the third TFT SW3. When the photosensitive organic layer includes a positive-type photoresist composition, the sixth region may be a partially light-transmitting portion and the seventh region may be a light-blocking portion. A transparent electrode layer is formed on the first base substrate 110, and then is patterned to form the first, second and third pixel electrodes 181, 183 and 185, and the first, second and third capacitor electrodes 182, 184 and 186.

According to the exemplary embodiments of the present invention, a first spacer is formed on the first switching element, a first capacitor electrode is formed on the first spacer and a sub-capacitor is defined by the first capacitor electrode and a common electrode. Thus, the electric capacity of a main capacitor is decreased by as much as the electric capacity of the sub-capacitor. Thus, the aperture ratio of the display apparatus may be improved by decreasing an area occupied by a first storage line.

Moreover, when the first capacitor electrode is formed on the first switching element, the first switching element and the first capacitor electrode are insulated from each other by disposing the first spacer on the first switching element. Thus, the formation of an off current (Ioff) in the first switching element may be prevented, and thus electric properties of the first switching element may be improved.

Moreover, in a plurality of switching elements, the heights of spacers formed on each of the switching elements are lower than a cell gap, which is a distance between the display substrate and the opposite substrate, and thus the margin of dropping liquid crystals may be improved and a plurality of spacers may be secured. Thus, formation of stains generated by changing the cell gap may be prevented.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display substrate, comprising:
a first switching element;
a first spacer arranged on the first switching element;
a first pixel electrode connected to a drain electrode of the first switching element;
a first capacitor electrode connected to the first pixel electrode and arranged on the first spacer;
a first storage line overlapping with the first pixel electrode; and
an alignment layer arranged on the first pixel electrode and the first capacitor electrode.

2. The display substrate of claim 1, further comprising:
a second pixel electrode arranged in a second pixel region adjacent to a first pixel region of a base substrate where the first pixel electrode is arranged;
a second switching element comprising a drain electrode connected to the second pixel electrode;
a second spacer arranged on the second switching element, the second spacer having the same height as the height of the first spacer; and
a second capacitor electrode connected to the second pixel electrode and arranged on the second spacer.

3. The display substrate of claim 2, further comprising:
a second storage line overlapped with the second pixel electrode, wherein an overlapping area of the second storage line and the second pixel electrode is substantially the same as an overlapping area of the first pixel electrode and the first storage line.

4. The display substrate of claim 3, further comprising:
a third spacer having a height greater than the first spacer and the second spacer.

5. The display substrate of claim 4, wherein a difference between the height of the first spacer and the height of the third spacer is no more than about 1.0 μm.

6. The display substrate of claim 3, wherein the first spacer and the second spacer perform a function of a cell gap spacer.

7. The display substrate of claim 1, further comprising:
a second spacer arranged in a second pixel region of a base substrate adjacent to a first pixel region where the first pixel electrode is arranged, the second spacer having a height greater than the height of the first spacer.

8. The display substrate of claim 7, wherein the second spacer performs a function of a cell gap spacer.

9. The display substrate of claim 8, further comprising:
a second pixel electrode arranged in the second pixel region; and
a second storage line overlapped with the second pixel electrode, an overlapping area of the second storage line and the second pixel electrode being wider than an overlapping area of the first storage line and the first pixel electrode.

10. The display substrate of claim 9, wherein a difference between the height of the first spacer and the height of the second spacer is no more than about 1.0 μm.

11. The display substrate of claim 7, further comprising:
a second pixel electrode arranged in the second pixel region; and
a second storage line overlapped with the second pixel electrode, an overlapping area of the second storage line and the second pixel electrode being wider than an overlapping area of the first storage line and the first pixel electrode.

12. The display substrate of claim 11, wherein a difference between the height of the first spacer and the height of the second spacer is no more than about 1.0 μm.

13. A display substrate comprising:
a first switching element;
a first spacer arranged on the first switching element;
a first pixel electrode connected to a drain electrode of the first switching element;
a first capacitor electrode connected to the first pixel electrode and arranged on the first spacer; and
an alignment layer arranged on the first pixel electrode and the first capacitor electrode.

14. The display substrate of claim 13, wherein the first spacer performs a function of a cell gap spacer.

15. The display substrate of claim 14, further comprising a first storage line overlapped with the first pixel electrode.

16. The display substrate of claim 13, further comprising a cell gap spacer arranged in a second pixel region adjacent to a first pixel region where the first pixel electrode is arranged.

17. The display substrate of claim 16, wherein a difference between the height of the first spacer and the height of the cell gap spacer is no more than about 1.0 μm.

18. The display substrate of claim 16, wherein a capacitor electrode is not arranged on the cell gap spacer, and the display substrate further comprises a second storage line overlapping with a second pixel electrode formed on the second pixel region.

19. A display apparatus, comprising:
a display substrate comprising a first switching element connected to a first pixel electrode, a first spacer arranged on the first switching element, a first capacitor electrode connected to the first pixel electrode, the first capacitor electrode being arranged on the first spacer, a first storage line overlapped with the first pixel electrode, and a first alignment layer arranged on the first pixel electrode and the first capacitor; and
an opposite substrate combined with the display substrate with liquid crystal molecules disposed therebetween, the opposite substrate comprising a common electrode facing the first pixel electrode and the first capacitor electrode, and a second alignment layer arranged on the common electrode.

20. The display apparatus of claim 19, wherein a portion of the first alignment layer disposed on the first capacitor electrode contacts with the second alignment layer.

21. The display apparatus of claim 20, wherein the display substrate further comprises:
a second pixel electrode arranged in a second pixel region adjacent to a first pixel region where the first pixel electrode is arranged; and
a second storage line overlapped with the second pixel electrode,
wherein an overlapping area of the first storage line and the first pixel electrode is substantially the same as an overlapping area of the second storage line and the second pixel electrode.

22. The display apparatus of claim 19, wherein a portion of the first alignment layer disposed on the first capacitor electrode is spaced apart from the second alignment layer.

23. The display apparatus of claim 22, wherein the difference of a distance (x) between the portion of the first alignment layer disposed on the first capacitor electrode and the second alignment layer is 0<x≦1.0 μm.

24. The display apparatus of claim 23, wherein the display substrate further comprises:
a second pixel electrode arranged in a second pixel region adjacent to a first pixel region where the first pixel electrode is arranged;
a switching element having a drain electrode connected to the second pixel electrode;
a second spacer arranged on the second switching element, the second spacer having substantially the same height as the height of the first spacer; and
a second capacitor electrode connected to the second pixel electrode, the second capacitor electrode being arranged on the second spacer.

25. The display apparatus of claim 24, wherein the display substrate further comprises:
a third spacer arranged in a region where signal lines are connected to the first switching element, the third spacer having a height greater than the height of the first spacer,
wherein a portion of the first alignment layer disposed on the third spacer contacts with the second alignment layer.

26. The display apparatus of claim 25, further comprising:
a second storage line overlapped with the second pixel electrode, wherein an overlapping area of the second pixel electrode and the second storage line is substantially the same as an overlapping area of the first pixel electrode and the first storage line.

27. The display apparatus of claim 23, wherein the display substrate further comprises:
a second pixel electrode arranged in a second pixel region adjacent to a first pixel region where the first pixel electrode is arranged;
a second switching element comprising a drain electrode connected to the second pixel electrode; and
a second spacer arranged on the second switching element, the second spacer having a height greater than the height of the first spacer.

28. The display apparatus of claim 27, further comprising:
a second storage line overlapped with the second pixel electrode, wherein an overlapping area of the second storage line and the second pixel electrode is wider than an overlapping area of the first storage line and the first pixel electrode.

29. The display apparatus of claim 28, wherein the opposite substrate further comprises:
a color filter having one color selected from red and green is arranged in the first pixel region of the opposite substrate; and
a color filter having a blue color is arranged in the second pixel region.

30. A display apparatus, comprising:
a display substrate comprising a first switching element connected to a first pixel electrode, a first spacer arranged on the first switching element, a first capacitor electrode connected to the first pixel electrode, the first capacitor electrode being arranged on the first spacer, and a first alignment layer arranged on the first pixel electrode and the first capacitor electrode; and
an opposite substrate combined with the display substrate with a liquid crystal layer therebetween, the opposite substrate comprising a common electrode facing the first pixel electrode and the first capacitor electrode, and a second alignment layer arranged on the common electrode.

31. The display apparatus of claim 30, wherein the first spacer performs a function of a cell gap spacer.

32. The display apparatus of claim 31, further comprising:
a first storage line overlapped with the first pixel electrode.

33. The display apparatus of claim 30, further comprising:
a cell gap spacer arranged in a second pixel region adjacent to a first pixel region where the first pixel electrode is arranged.

34. The display apparatus of claim 33, wherein the difference (x) between the height of the first spacer and the cell gap spacer is 0<x≦1.0 μm.

35. The display apparatus of claim 33, wherein a capacitor electrode is not arranged on the cell gap spacer, and the display substrate further comprises a second storage line overlapping with a second pixel electrode arranged in the second pixel region.
